(19) United States
(12) Patent Application Publication
(10) Pub. No.: US 2016/0134871 A1
(43) Pub. Date: May 12, 2016

(54) METHOD AND DEVICE FOR ENCODING IMAGE USING PREPROCESSING

(71) Applicant: SAMSUNG ELECTRONICS CO., LTD., Suwon-si (KR)

(72) Inventors: Dae-Hee KIM, Suwon-si (KR); Young-jin KWAK, Yongin-si (KR); Woong-il CHOI, Osan-si (KR); Dai-woong CHOI, Suwon-si (KR)

(73) Assignee: SAMSUNG ELECTRONICS CO., LTD., Suwon-si (KR)

(21) Appl. No.: 14/939,265

(22) Filed: Nov. 12, 2015

(30) Foreign Application Priority Data
Nov. 12, 2014 (KR) 10-2014-0157331

(51) Int. Cl. H04N 19/124; H04N 19/176; H04N 19/196; H04N 19/162

(52) U.S. Cl. CPC H04N 19/124; H04N 19/162; H04N 19/176; H04N 19/198

(57) ABSTRACT

A method of encoding an image includes obtaining a quantization parameter; determining a size of a smoothing block based on the quantization parameter, determining threshold values based on a main pixel in the smoothing block, selecting a pixel having a pixel value between the threshold values, from among pixels included in the smoothing block, performing a smoothing operation with respect to the main pixel based on the pixel value of the selected pixel, and encoding an image with respect to which the smoothing operation is performed.

### CROSS-REFERENCE TO RELATED APPLICATION

This application claims priority to Korean Patent Application No. 10-2014-0157331, filed on Nov. 12, 2014, in the Korean Intellectual Property Office, the disclosure of which is incorporated herein in its entirety by reference.

### BACKGROUND

1. Field

The exemplary embodiments relate to a method and a device for encoding an image using preprocessing, and more particularly, to a method of preprocessing an image to be encoded.

2. Description of the Related Art

A person's vision may have the ability to discriminate between changes in brightness of an image within a limited range. For example, people are insensitive to a change in brightness in a bright area whereas people are sensitive to a change in brightness in a dark area.

Generally, when compressing an image, pixel values of an image are replaced with values in a range in which people may not visually perceive the difference therebetween so that data is changed to data that may be easily compressed. For example, through a transformation, such as discrete cosine transformation (DCT), an image is transformed to be in the frequency domain and then a high frequency element is removed.

In the related art, a high frequency is removed in the frequency domain with respect to an image so that similar pixel values which are not visually distinguishable are removed. Recently, as the need to increase compression efficiency has increased, a smoothing technology performed with respect to similar pixel values which are not visually distinguishable in a pixel domain has been required.

### SUMMARY

Provided are a method and a device of selecting similar pixel values which are not visually distinguishable in a pixel domain, and performing a smoothing operation by using the selected pixels.

Additional aspects will be set forth in part in the description which follows and, in part, will be apparent from the description of the exemplary embodiments, or may be learned by practice of the presented exemplary embodiments.

According to an aspect of an exemplary embodiment, there is provided a method of encoding an image, the method including: obtaining a quantization parameter; determining a size of a smoothing block based on the quantization parameter; determining threshold values based on a main pixel in the smoothing block; selecting a pixel having a pixel value between the threshold values, from among pixels included in the smoothing block; performing a smoothing operation with respect to the main pixel based on the pixel value of the selected pixel; and encoding an image with respect to which the smoothing operation is performed.

The selecting the pixel may include: determining the main pixel in the smoothing block; determining the threshold values based on a pixel value of the main pixel; and selecting the pixel having a pixel value between the determined threshold values, from among the pixels included in the smoothing block.

The main pixel may be located at an intersection of a central row and a central column in the smoothing block.

The determining of the size of the smoothing block may further include determining the size of the smoothing block based on a resolution of the image, a complexity of the image, or a combination of the resolution of the image and a complexity of the image.

The method may further include setting the quantization parameter based on input received from a user.

The performing of the smoothing operation may include applying a Gaussian function determined based on the quantization parameter to a pixel value of the selected pixel.

The performing of the smoothing operation may include performing the smoothing operation based on an average of pixel values of the selected pixel and other selected pixels.

According to an aspect of another exemplary embodiment, there is provided a device for encoding an image, the device including: a block size determiner configured to obtain a quantization parameter, and determine a size of a smoothing block based on the quantization parameter; a pixel selector configured to select a pixel having a pixel value between threshold values determined with respect to a main pixel in the smoothing block, from among pixels included in the smoothing block; a smoothing operation performer configured to perform a smoothing operation with respect to the main pixel based on the pixel value of the selected pixel; and an image encoder configured to encode an image with respect to which the smoothing operation is performed.

The pixel selector may be configured to determine the main pixel of the smoothing block, determine threshold values based on a pixel value of the determined main pixel, and select the pixel having a pixel value between the determined threshold values from among the pixels included in the smoothing block.

The main pixel may be located at an intersection of a central row and a central column in the smoothing block.

The block size determiner may be further configured to determine the size of the smoothing block based on a resolution of the image, a complexity of the image, or a combination of the resolution of the image and a complexity of the image.

The device may be configured to receive input from a user and set the quantization parameter based on the received input.

The smoothing operation performer may be configured to perform the smoothing operation by applying a Gaussian function determined based on the quantization parameter to a pixel value of the selected pixel.

The smoothing operation performer may be configured to perform the smoothing operation based on an average of pixel values of the selected pixel and other selected pixels.

According to an aspect of another exemplary embodiment, there is provided a non-transitory computer-readable recording medium having recorded thereon a program for performing the method according to an aspect of an exemplary embodiment.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 illustrates a block diagram of a device configured to smooth an image, according to an exemplary embodiment;

FIG. 2 illustrates a flowchart showing a method of encoding, according to an exemplary embodiment;

FIG. 3 illustrates a flowchart showing a method of selecting at least one pixel with respect to which a smoothing operation is to be performed, according to an exemplary embodiment;

FIGS. 4A and 4B illustrates views for explaining a method of determining a size of a smoothing block, according to an exemplary embodiment;

FIG. 5 illustrates a graph for explaining a method of determining a threshold value, according to an exemplary embodiment;

FIGS. 6A, 6B and 6C illustrate data tables for explaining a method of performing a smoothing operation, according to an exemplary embodiment;

FIGS. 7A, 7B, 7C and 7D illustrates views for explaining a method of performing a smoothing operation by using a Gaussian function, according to an exemplary embodiment; and

FIG. 8 illustrates a block diagram of an encoding device, according to an exemplary embodiment.

### DETAILED DESCRIPTION

The exemplary embodiments will now be described more fully hereinafter with reference to the accompanying drawings so that this disclosure is thorough and complete and fully conveys the exemplary embodiments to those of ordinary skill in the art. The exemplary embodiments may, however, be embodied in many different forms and should not be construed as being limited to the exemplary embodiments set forth herein. For better understanding of the exemplary embodiments, at times certain elements may be omitted, and like reference numerals refer to the like elements throughout.

It will be understood that when a region is referred to as being “connected to” another region, the region can be “directly connected to” another region or “electrically connected to” another region, or intervening elements may be present. Throughout the specification, when a portion is described as “including” an element, another element may be further included, rather than excluding the existence of the other element, unless otherwise described.

Hereinafter, the exemplary embodiments will be described more fully with reference to the accompanying drawings.

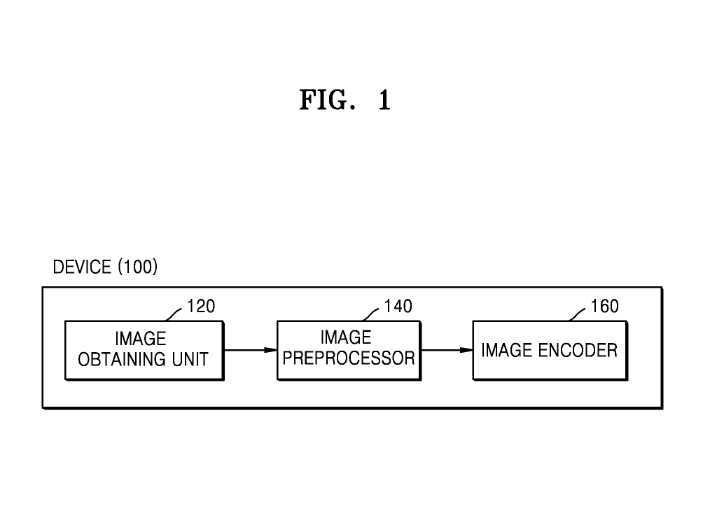

FIG. 1 illustrates a block diagram of a device configured to smooth an image, according to an exemplary embodiment.

According to an exemplary embodiment, an image obtaining unit 120 (e.g., image obtainer) of a device 100 may obtain an image. The image obtaining unit 120 of the device 100 may directly collect an image by using a processor stored within the image obtaining unit 120, and may also collect an image from outside.

An image preprocessor 140 of the device 100 may preprocess an image before encoding the image in order to increase encoding efficiency of the image. For example, the image preprocessor 140 of the device 100 may smooth an image in a pixel domain before encoding the image.

The image preprocessor 140 of the device 100 may determine a size of a smoothing block to smooth the obtained image. For example, the image preprocessor 140 of the device 100 may determine a size of a smoothing block based on complexity information of the image, resolution information of the image, or a combination thereof, which are obtained from a preset quantization parameter and the image.

The image preprocessor 140 of the device 100 may perform a smoothing operation by using the smoothing block having a size which is determined as described above. The device 100 may select a pixel used for smoothing from among pixels included in a smoothing block. For example, the device 100 may select a pixel having a similar pixel value to a pixel value of a main pixel, in which the difference therebetween may not be visually distinguished.

The image preprocessor 140 of the device 100 may perform a smoothing operation by using the selected pixels. For example, the image preprocessor 140 of the device 100 may perform a smoothing operation based on an average of pixel values of the selected pixels, or may perform a smoothing operation by applying a Gaussian function to the selected pixels. However, the method of performing a smoothing operation is not limited thereto.

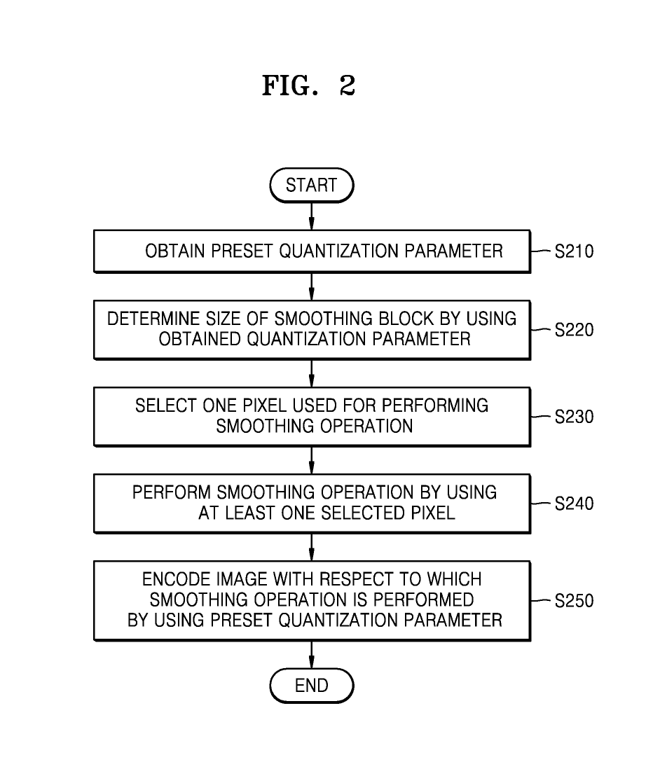

FIG. 2 illustrates a flowchart showing a method of encoding, according to an exemplary embodiment.

In operation S210, the device 100 may obtain a preset quantization parameter.

According to an exemplary embodiment, the device 100 may obtain an image by using a camera module included in the device 100. Also, the device 100 may obtain an image from an external device, although is not limited to obtaining an image. An image that the device 100 obtains may include a photo. Also, the device 100 may obtain a video or other types of information.

According to an exemplary embodiment, the device 100 may receive input from a user to set a quantization parameter. Also, the device 100 may receive parameter information from an external device and then set a quantization parameter. The quantization parameter refers to a parameter used in an image encoding process or an image decoding process of the device 100. The device 100 may set a quantization parameter according to the aforementioned methods, but a method of setting a quantization parameter is not limited thereto.

According to an exemplary embodiment, the device 100 may obtain a preset quantization parameter. For example, when the device 100 encodes the obtained image to a bit rate determined by input from a user, the device 100 may set a quantization parameter based on the determined bit rate to then obtain a preset quantization parameter.

In operation S220, the device 100 may determine a size of a smoothing block based on the obtained quantization parameter.

According to an exemplary embodiment, the device 100 may determine a size of a smoothing block based on the obtained quantization parameter. The size of the smoothing block refers to a size of an image block that is to be a subject of smoothing when the device 100 performs a smoothing operation within the obtained image. For example, the device 100 may set a size of a smoothing block as 7×7, 5×5, or 3×3, but the size of the smoothing block is not limited thereto.

According to an exemplary embodiment, the device 100 may determine a size of a smoothing block based on a size of the obtained quantization parameter. For example, when a preset first quantization parameter Qp1 is greater than a preset second quantization parameter Qp2, a size of a first smoothing block, which is determined, by the device 100, based on the first quantization parameter Qp1, may be greater than a size of a second smoothing block, which is determined based on the second quantization parameter Qp2.

According to an exemplary embodiment, the device 100 may determine a size of a smoothing block based on resolution information of an image, which is collected from the image. For example, when a first resolution collected from a first image obtained by the device 100 is greater than a second resolution collected from a second image, a size of a first smoothing block, which is determined based on the first resolution by the device, may be greater than a size of a second smoothing block, which is determined based on a size of the second resolution. For example, when a resolution of a first image is 1020×1080 and a resolution of a second image is 800×600, a size of a first smoothing block 410 of a first image, determined by the device 100, may be greater than a size of a second smoothing block 420 of a second image.

According to an exemplary embodiment, the device 100 may obtain image complexity information collected from the image. The image complexity refers to a degree of a deviation of pixel values for pixels included in a smoothing block. For example, when a deviation of pixel values included in a smoothing block is large, the device 100 may determine that a complexity is large.

The device 100 may determine a size of a smoothing block based on an image complexity collected from the image. When a first image complexity collected from a first image obtained by the device 100 is less than a second image complexity collected from a second image, a size of the first smoothing block 410, determined based on the first image complexity by the device 100 may be greater than a size of the second smoothing block 420, determined based on the second image complexity.

According to an exemplary embodiment, the device 100 may determine a size of a smoothing block based on a preset quantization parameter, a resolution of an image obtained from the image, an image complexity obtained from the image, or a combination thereof.

According to an exemplary embodiment, the device 100 may perform a smoothing operation based on a determined size of a smoothing block. For example, the device 100 may perform a smoothing operation by moving a smoothing block having a determined size from left to right in a pixel unit. In some exemplary embodiments, the device 100 may perform a smoothing operation by moving a smoothing block having a determined size up and down in a pixel unit, but exemplary embodiments are not limited thereto.

In operation S230, the device 100 may select at least one pixel used for performing a smoothing operation.

According to an exemplary embodiment, the device 100 may determine a pixel as a main pixel, from among pixels included in a smoothing block having a determined size. The main pixel refers to a pixel adjusted by the device 100 when the device 100 performs a smoothing operation on pixels in a smoothing block. For example, the device 100 may perform a smoothing operation by adjusting a main pixel to have an average of pixel values of selected pixels.

According to an exemplary embodiment, the device 100 may determine a threshold value based on a pixel value of the determined main pixel. The device 100 may detect a range of a pixel value corresponding to a pixel value of a main pixel, and then determine a boundary value of the detected range as a threshold value.

In some exemplary embodiments, the device 100 may select at least one pixel used for a smoothing operation, from among pixels in a smoothing block, by using determined threshold values. For example, the device 100 may select at least one pixel including pixel values between threshold values.

In operation S240, the device 100 may perform a smoothing operation by using at least one selected pixel.

According to an exemplary embodiment, the device 100 may perform a smoothing operation by using an average of pixel values of at least one selected pixel. For example, when pixel values of three selected pixels are respectively 200, 205, and 210, the device 100 may adjust a main pixel to be 205, which is the average of the pixel values of the selected pixels.

According to an exemplary embodiment, the device 100 may perform a smoothing operation by applying a Gaussian function to pixel values of at least one selected pixel. For example, the device 100 may determine a distribution of a Gaussian function by using a preset quantization parameter, and perform a smoothing operation by applying Gaussian function values obtained from the determined distribution to pixel values of the selected pixel. However, exemplary embodiments are not limited thereto, and the device 100 may perform a smoothing operation in various ways.

In operation S250, the device 100 may encode an image with respect to which a smoothing operation is performed.

According to an exemplary embodiment, the device 100 may encode an image with respect to which a smoothing operation is performed by using a preset quantization parameter. For example, the device 100 may encode an image with respect to which a smoothing operation is performed by using a preset quantization parameter Qp.

According to an exemplary embodiment, the device 100 may quantize an image by using a quantization parameter used for determining a size of a smoothing block. The quantization may refer to mapping an input value in a certain range to a representative value of the certain range with respect to an input image. For example, when the device 100 performs a quantization operation with 10 as a quantization parameter, input values between 0 and 9 may be adjusted to be 0 after the quantization operation, and data between 10 and 19 may be adjusted to be 1.

The device 100 may encode an image by using various standard methods such as H.264 (AVC) or H.265 (HEVC), but exemplary embodiments are not limited thereto. The device may also encode an image in various methods included non-standard methods.

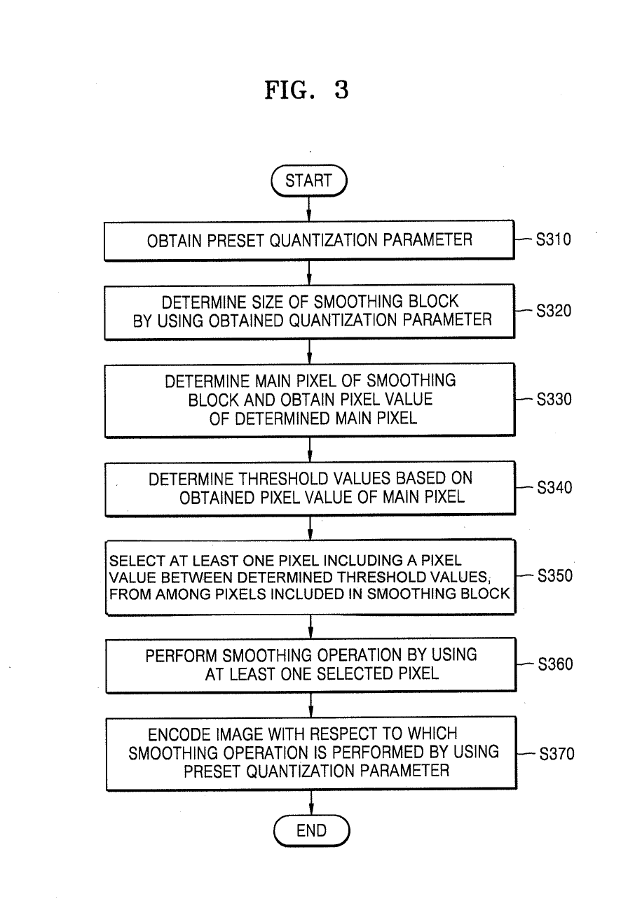

FIG. 3 illustrates a flowchart showing a method of selecting at least one pixel with respect to which a smoothing operation is to be performed, according to an exemplary embodiment.

In operation S310, the device 100 may obtain a preset quantization parameter. A detailed description of obtaining the preset quantization parameter by the device 100 was given above with respect to operation S210.

In operation S320, the device 100 may determine a size of a smoothing block by using the determined quantization parameter. A detailed description of determining the size of the smoothing block by the device 100 was given above with respect to operation S220.

In operation S330, the device 100 may determine a main pixel of a smoothing block, and obtain a pixel value of the determined main pixel.

According to an exemplary embodiment, the device 100 may determine a pixel, from among pixels included in a smoothing block having the determined size, as a main pixel. For example, the device 100 may determine a pixel, which is located at the intersection of a central row within a smoothing block and a central column within the smoothing block, as a main pixel. The method of determining a main pixel is not limited thereto, and the device 100 may determine a main pixel in various ways.

In operation S340, the device 100 may determine threshold values based on a pixel value of the determined main pixel.

According to an exemplary embodiment, the device 100 may determine a threshold value based on a pixel value of the determined main pixel. The device 100 may detect a range of a pixel value corresponding to a pixel value of a main pixel, and then determine a boundary value of the detected range as a threshold value.

For example, the device 100 may store a graph according to Weber-Fechner's law, or a data table according to Weber-Fechner's law. The device 100 may detect a range of a pixel value, corresponding to a pixel value of a main pixel, from the stored graph or data table, and determine a boundary value of the detected range of the pixel value as a threshold value.

In operation S350, the device 100 may select at least one pixel including a pixel value between the determined threshold values, from among a plurality of pixels included in a smoothing block.

According to an exemplary embodiment, the device 100 may select at least one pixel used for performing a smoothing operation, from among pixels in a smoothing block, by using the determined threshold value. For example, when a pixel value of a main pixel is A, and a range of a pixel value detected after applying A of the pixel value to Weber-Fechner's law is between M and N, inclusive, the device 100 may determine a first threshold value as M, and a second threshold value as N, and select pixels having a pixel value between M and N, inclusive, from among a plurality of pixels in a smoothing block.

In operation S360, the device 100 may perform a smoothing operation by using at least one selected pixel. A detailed description of performing a smoothing operation by the device 100 was described above in operation S240.

In operation S370, the device 100 may encode an image with respect to which a smoothing operation is performed by using a quantization parameter. A detailed description of encoding an image with respect to which a smoothing operation is performed using a quantization parameter by the device 100 was described above in operation S250.

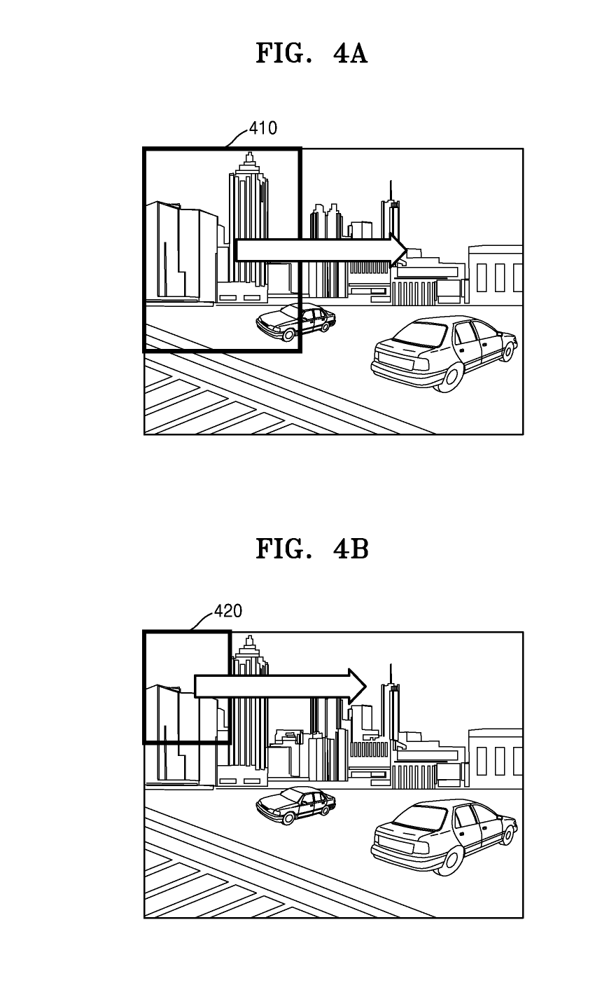

FIGS. 4A and 4B illustrate views for explaining a method of determining a size of a smoothing block, according to an exemplary embodiment.

Referring to FIGS. 4A and 4B, the device 100 may determine a size of a smoothing block by using a preset quantization parameter. For example, when the preset first quantization parameter Qp1 is greater than the preset second quantization parameter Qp2, a size of the first smoothing block 410, which is determined based on the first quantization parameter Qp1 by the device 100, may be greater than a size of the second smoothing block 420, which is determined based on the second quantization parameter Qp2.

According to an exemplary embodiment, the device 100 may determine a size of a smoothing block based on resolution information of an image, which is collected from the image. For example, when a first resolution collected from a first image obtained by the device 100 is greater than a second resolution collected from a second image, a size of the first smoothing block 410, which is determined based on the first resolution by the device 100, may be greater than a size of the second smoothing block 420, which is determined based on the second resolution. For example, when a resolution of a first image is 1920×1080, and a resolution of a second image is 800×600, a size of the smoothing block 410 of the first image determined by the device 100 may be greater than a size of the smoothing block 420 of the second image.

According to an exemplary embodiment, the device 100 may obtain image complexity information collected from an image. For example, when a deviation of pixel values included in a smoothing block is large, the device 100 may determine that a complexity is large.

The device 100 may determine a size of a smoothing block based on an image complexity collected from an image. When a first image complexity collected from a first image obtained by the device 100 is less than a second image complexity collected from a second image, a size of the first smoothing block 410, which is determined based on the first image complexity by the device 100, may be greater than a size of the second smoothing block 420, determined based on the second image complexity.

According to an exemplary embodiment, the device 100 may determine a size of a smoothing block based on a preset quantization parameter, a resolution of an image obtained from the image, an image complexity obtained from the image, or a combination thereof.

According to an exemplary embodiment, the device 100 may perform a smoothing operation based on a determined size of a smoothing block. For example, the device 100 may perform a smoothing operation by moving a smoothing block having a determined size from left to right in a pixel unit. In some exemplary embodiments, the device 100 may perform a smoothing operation by moving a smoothing block having a determined size up and down in a pixel unit, but exemplary embodiments are not limited thereto.

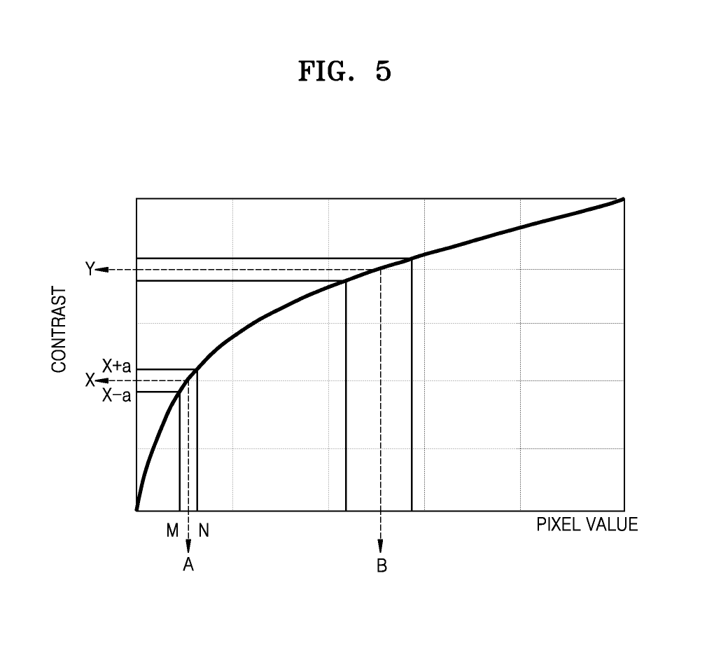

FIG. 5 illustrates a graph for explaining a method of determining a threshold value, according to an exemplary embodiment.

According to an exemplary embodiment, the device 100 may obtain a threshold value based on a pixel value of an obtained main pixel. Referring to FIG. 5, the device 100 inputs a pixel value of an obtained main pixel to a curve formed according to Weber-Fechner's law to obtain a contrast value corresponding to the pixel value of the main pixel.

For example, when a pixel value of a main pixel is A, the device 100 may obtain X as a contrast value, and when a pixel value of a main pixel is B, the device 100 may obtain Y as a contrast value.

According to an exemplary embodiment, the device 100 may determine a threshold contrast value with respect to the obtained contrast value, based on a preset value. In some exemplary embodiments, the device 100 may determine pixel values corresponding to the determined threshold contrast value as threshold values.

For example, when the obtained contrast value is X, and a preset certain value is a, the device 100 may determine (X−a), which is smaller than X by a, and (X+a), which is greater than X by a, as threshold contrast values. In some exemplary embodiments, the device 100 inputs the obtained threshold contrast values to the curve according to Weber-Fechner's law to obtain a first threshold value M and a second threshold value N. The device 100 may determine a predetermined value based on human visual recognition ability, or may receive a predetermined value from outside. In some exemplary embodiments, the device 100 may determine a preset predetermined value by receiving an input from a user, but exemplary embodiments are not limited thereto.

In some exemplary embodiments, the device 100 may obtain threshold values in various ways and is not limited to the aforementioned methods.

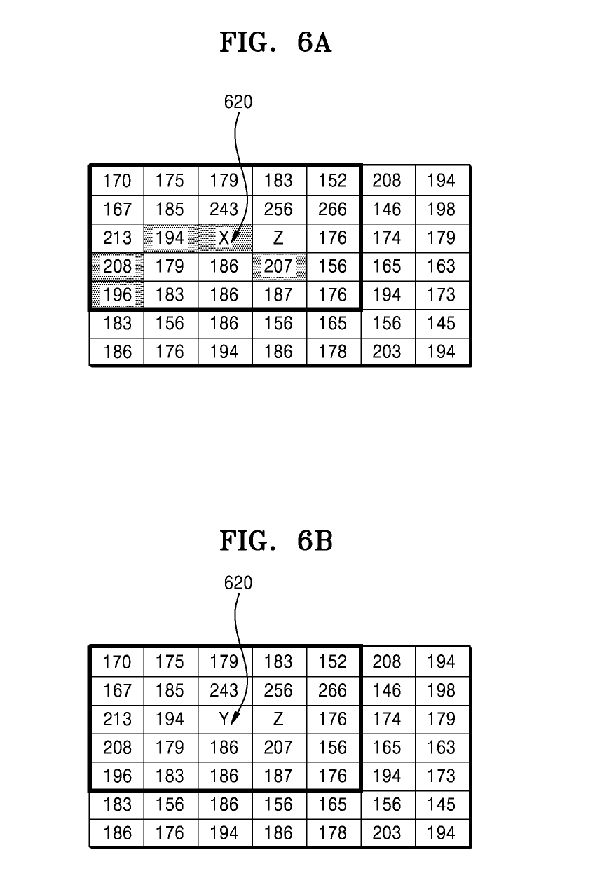

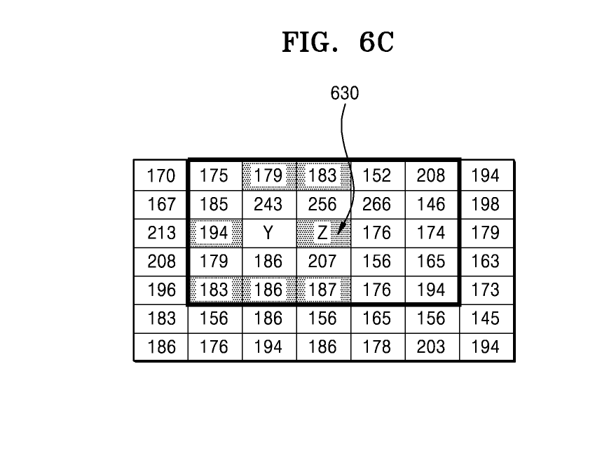

FIGS. 6A, 6B and 6C illustrate data tables for explaining a method of performing a smoothing operation, according to an exemplary embodiment.

Referring to FIGS. 6A and 6B, the device 100 may perform a smoothing operation by using an average of pixel values included in at least one selected pixel.

Referring to FIG. 6A, the device 100 may select a main pixel 620 from among pixels in a smoothing block having a determined size, and then obtain a pixel value of the selected main pixel. For example, the device 100 may select a pixel, which is located at the intersection of a central row and a central column, from among pixels of a smoothing block having the determined size as the main pixel 620.

According to an exemplary embodiment, the device 100 may select pixels used for performing a smoothing operation based on a pixel value of the selected main pixel 620. For example, when a first threshold value, which is obtained based on a pixel value of the main pixel 620 by the device 100, is 190, and a second threshold value is 210, the device 100 may select pixels including a pixel value between the first threshold value and the second threshold value, from among pixels in a smoothing block having a determined size.

Referring to FIG. 6B, the device 100 may obtain an average of pixel values of the selected pixels to adjust a pixel value of the selected main pixel. For example, the device 100 may adjust a pixel value of the selected main pixel to be Y, wherein Y is an average of pixel values of the selected pixels.

Referring to FIG. 6C, the device 100 may perform a smoothing operation by moving a smoothing block having a determined size from left to right in a pixel unit. The device 100 may select a main pixel 630 from among pixels within a smoothing block, which is moved from left to right, and then obtain a pixel value of the selected main pixel 630.

The device 100 may select pixels to be used for performing a smoothing operation based on a pixel value of the selected main pixel 630. For example, the device 100 may determine a first threshold value and a second threshold value based on the pixel value of the main pixel 630, and then select pixels including a pixel value between the first threshold value and the second threshold value. The device 100 may adjust a pixel value of the main pixel 630 to be an average of pixel values (179, 183, 194, 187, 183, 186, and Z) of the selected pixel values.

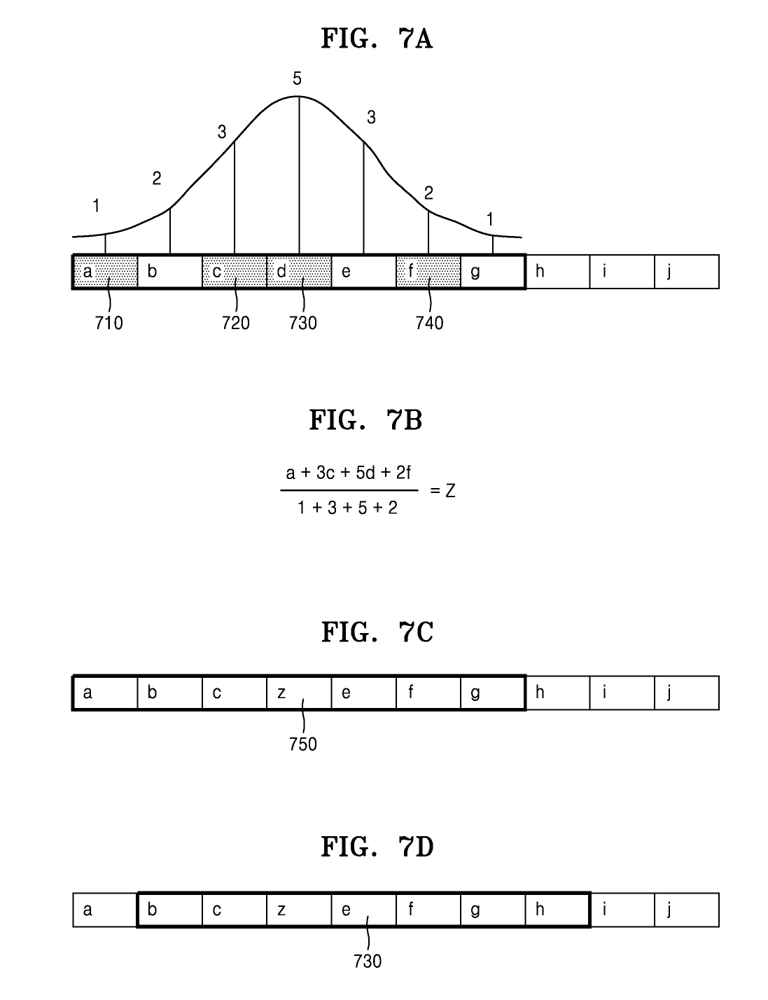

FIG. 7 illustrates views for explaining a method of performing a smoothing operation by using a Gaussian function, according to an exemplary embodiment.

According to an exemplary embodiment, the device 100 may determine a distribution of a Gaussian function to be applied to at least one selected pixel. For example, the device 100 may determine a distribution of a Gaussian function based on a preset quantization parameter, or a pixel value of a selected main pixel, but exemplary embodiments are not limited thereto. The device 100 may determine a distribution of a Gaussian function in various ways.

Referring to FIG. 7A, the device 100 may apply the Gaussian function to each of selected pixels in a smoothing block to obtain a Gaussian function value corresponding to each of the selected pixels. For example, the device 100 may obtain 1 as a Gaussian function value, corresponding to a pixel value of a selected pixel 710. Also, the device 100 may obtain 3 as a Gaussian function value, corresponding to a pixel value c of a selected pixel 720; 5 as a Gaussian function value, corresponding to a pixel value d of a selected pixel 730; and 2 as a Gaussian function value, corresponding to a pixel value f of a selected pixel 740.

Referring to FIG. 7B, the device 100 may determine a smoothing value Z by using pixel values included in the selected pixels and Gaussian function values corresponding to each of the pixel values. For example, the device 100 may multiply each of the Gaussian function values corresponding to the selected pixel by each of the pixel values included in the selected pixels to determine multiplication products and add the multiplication products together, and then divide the sum of the multiplication products by the sum of the Gaussian function values to determine the smoothing value Z.

Referring to FIG. 7C, the device 100 may adjust a pixel value of the main pixel 750 to be the determined smoothing value Z.

Referring to FIG. 7D, the device 100 may perform a smoothing operation by moving a smoothing block having a determined size from left to right in pixel units. The device 100 may perform a smoothing operation for pixels in the smoothing block, moved from left to right, by using the aforementioned method. For example, the device 100 may select the pixel 730 as the main pixel, and adjust a pixel value of the selected main pixel to be the determined smoothing value by using the aforementioned method.

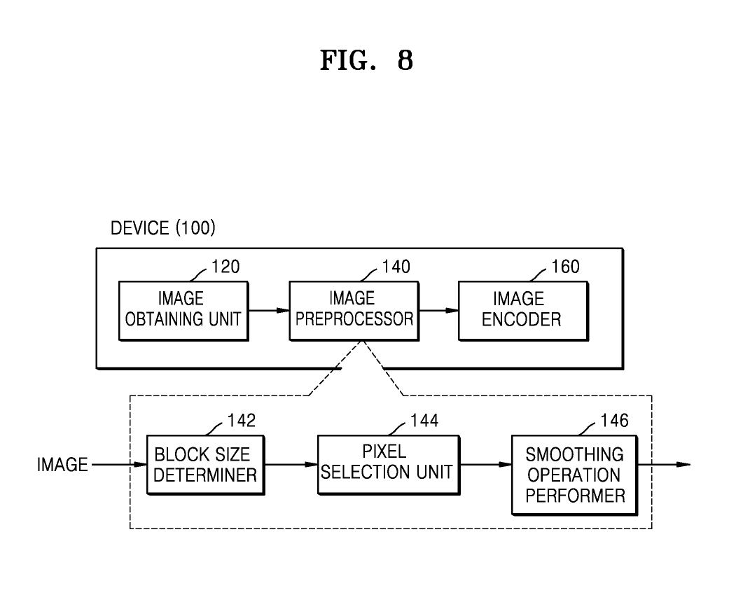

FIG. 8 illustrates a block diagram of an encoding device, according to an exemplary embodiment.

According to an exemplary embodiment, the image obtaining unit 120 (e.g., image obtainer) of the device 100 may obtain an image by using a camera module (e.g., camera). In some exemplary embodiments, the image obtaining unit 120 of the device 100 may obtain an image from an external device, but exemplary embodiments are not limited thereto. The image obtained by the image obtaining unit 120 of the device 100 may include a photo or a video.

According to an exemplary embodiment, the device 100 may set a quantization parameter after receiving an input from a user. In some exemplary embodiments, the device 100 may set a quantization parameter after receiving parameter information from an external device. The quantization parameter refers to a parameter used while the device 100 encodes or decodes an image. The device 100 may set a quantization parameter in various ways and is not limited to the aforementioned method.

According to an exemplary embodiment, a block size determiner 142 of the device 100 may obtain a preset quantization parameter. For example, when encoding an obtained image to a bit rate determined by an input from a user, the block size determiner 142 of the device 100 may obtain a preset quantization parameter based on the determined bit rate.

According to an exemplary embodiment, the block size determiner 142 of the device 100 may determine a size of a smoothing block by using an obtained quantization parameter. For example, the device 100 may determine a size of a smoothing block to be 7×7, 5×5, or 3×3, but exemplary embodiments are not limited thereto. The device may determine a size of a smoothing block in various ways. According to an exemplary embodiment, the block size determiner 142 of the device 100 may determine a size of a smoothing block based on a size of an obtained quantization parameter. For example, when the preset first quantization parameter Qp1 is greater than the preset second quantization parameter Qp2, a size of a first smoothing block, which is determined based on the first quantization parameter Qp1 by the block size determiner 142 of the device 100, may be greater than a size of a second smoothing block, which is determined based on the second quantization parameter Qp2.

According to an exemplary embodiment, the block size determiner 142 of the device 100 may determine a size of a smoothing block based on resolution information of an image, collected from the image. For example, when a first resolution collected from a first image by the device 100 is greater than a second resolution collected from a second image, a size of the first smoothing block 410, which is determined based on the first resolution by the block size determiner 142 of the device 100, may be greater than a size of the second smoothing block 420, which is determined based on the second resolution. For example, when a resolution of a first image is 1020×1080, and a resolution of a second image is 800×600, a size of the first smoothing block 410 of the first image, which is determined by the block size determiner 142 of the device 100, may be greater than a size of the second smoothing block 420 of the second image.

According to an exemplary embodiment, the device 100 may obtain image complexity information collected from an image. For example, when a deviation of pixel values included in a smoothing block is large, the device 100 may determine that a complexity may be large.

The block size determiner 142 of the device 100 may determine a size of a smoothing block based on an image complexity collected from an image. When a first image complexity collected from a first image obtained by the device 100 is smaller than a second image complexity collected from a second image, a size of the first smoothing block 410, which is determined based on the first image complexity by the block size determiner 142 of the device 100, may be greater than a size of the second smoothing block 420, which is determined based on the second image complexity.

According to an exemplary embodiment, the block size determiner 142 of the device 100 may determine a size of a smoothing block by using a preset quantization parameter, a resolution of an image collected from the image, an image complexity collected from an image, or a combination thereof.

According to an exemplary embodiment, the device 100 may perform a smoothing operation based on a determined size of a smoothing block. For example, the device 100 may perform a smoothing operation by moving a smoothing block having a determined size from left to right in a pixel unit. In some exemplary embodiments, the device 100 may perform a smoothing operation by moving a smoothing block having a determined size up and down in a pixel unit, but exemplary embodiments are not limited thereto.

According to an exemplary embodiment, a pixel selection unit 144 (e.g., pixel selector) of the device 100 may determine a pixel, from among pixels in a smoothing block having a determined size, as a main pixel. For example, the pixel selection unit 144 of the device 100 may determine a pixel, which is located at the intersection of a central row and a central column, from among pixels in a smoothing block having a determined size as a main pixel.

According to an exemplary embodiment, the pixel selection unit 144 of the device 100 may determine a threshold value based on a pixel value of the determined main pixel. The pixel selection unit 144 of the device 100 may detect a range of a pixel value corresponding to a pixel value of a main pixel, and then determine a boundary value of the detected range as a threshold value. In some exemplary embodiments, the pixel selection unit 144 of the device 100 may select at least one pixel used for performing a smoothing operation from among pixels in a smoothing block by using the determined threshold value.

According to an exemplary embodiment, a smoothing operation performer 146 of the device 100 may perform a smoothing operation by using an average of pixel values of at least one selected pixel. For example, when pixel values of three selected pixels are respectively 200, 205, and 210, the smoothing operation performer 146 of the device 100 may adjust a main pixel to be 205, the average of the pixel values of the selected pixels.

According to an exemplary embodiment, the smoothing operation performer 146 of the device 100 may perform a smoothing operation by applying a Gaussian function to pixel values of at least one selected pixel. For example, the smoothing operation performer 146 of the device 100 may determine a distribution of a Gaussian function by using a preset quantization parameter. In some exemplary embodiments, the smoothing operation performer 146 of the device 100 may perform a smoothing operation by applying Gaussian function values obtained from the determined distribution to pixel values of selected pixels. But exemplary embodiments are not limited thereto, and the smoothing operation performer 146 of the device 100 may perform a smoothing operation in various ways.

According to an exemplary embodiment, the image encoder 160 of the device 100 may encode an image with respect to which a smoothing operation is performed, by using a preset quantization parameter. For example, the image encoder 160 of the device 100 may encode an image with respect to which a smoothing operation is performed by using a quantization parameter Qp used when determining a size of a smoothing block.

According to an exemplary embodiment, the image encoder 160 of the device 100 may quantize an image by using the quantization parameter Qp used when determining a size of a smoothing block. The term “quantization” refers to mapping of an input value in a certain range to a representative value of the certain range with respect to an input image. For example, when the image encoder 160 of the device 100 performs a quantization operation with 10 as a quantization parameter, input values between 0 and 9 may be adjusted to be 0 after the quantization operation, and data between 10 and 19 may be adjusted to be 1.

The image encoder 160 of the device 100 may encode an image by using various standard methods such as H.264, or H.265, but exemplary embodiments are not limited thereto. The image encoder 160 may encode an image in various ways including a non-standard method.

The one or more exemplary embodiments may be embodied as a non-transitory computer-readable recording medium, e.g., a program module to be executed in computers, which include computer-readable commands. The non-transitory computer-readable recording medium may include an arbitrary available medium accessible by a computer, and examples thereof include all volatile and non-volatile media and separable and non-separable media. Further, examples of the non-transitory computer-readable recording medium may include a computer storage medium and a communication medium. Examples of the computer storage medium include all volatile and non-volatile media and separable and non-separable medial, which have been implemented by an arbitrary method or technology, for storing information such as computer-readable commands, data structures, program modules, and other data. The communication medium typically includes a computer-readable command, a data structure, a program module, other data of a modulated data signal, or another transmission mechanism, and an example thereof includes an arbitrary information transmission medium.

While the exemplary embodiments have been particularly shown and described with reference to certain exemplary embodiments thereof, it will be understood by one of ordinary skill in the art that various changes in form and details may be made therein without departing from the spirit and scope of the exemplary embodiments as defined by the following claims. Hence, it will be understood that the exemplary embodiments described above do not limit the scope of the exemplary embodiments. For example, each component described as a single type may be executed in a distributed manner, and components described as being distributed may also be executed in an integrated form.

The scope of the exemplary embodiments is indicated by the claims rather than by the detailed description of the exemplary embodiments, and it should be understood that the claims and all modifications or modified forms drawn from the concept of the claims are included in the scope of the exemplary embodiments.

What is claimed is:

1. A method of encoding an image, the method comprising:
obtaining a quantization parameter;
determining a size of a smoothing block based on the quantization parameter;
determining threshold values based on a main pixel in the smoothing block;
selecting a pixel having a pixel value between the threshold values, from among pixels included in the smoothing block;
performing a smoothing operation with respect to the main pixel based on the pixel value of the selected pixel; and
encoding an image with respect to which the smoothing operation is performed.

2. The method of claim 1, wherein the selecting the pixel comprises:
determining the main pixel in the smoothing block;
determining the threshold values based on a pixel value of the main pixel; and
selecting the pixel having a pixel value between the determined threshold values, from among the pixels included in the smoothing block.

3. The method of claim 2, wherein the main pixel is located at an intersection of a central row and a central column in the smoothing block.

4. The method of claim 1, wherein the determining of the size of the smoothing block further comprises determining the size of the smoothing block based on a resolution of the image, a complexity of the image, or a combination of the resolution of the image and a complexity of the image.

5. The method of claim 1, further comprising setting the quantization parameter based on input received from a user.

6. The method of claim 1, wherein the performing of the smoothing operation comprises applying a Gaussian function determined based on the quantization parameter to a pixel value of the selected pixel.

7. The method of claim 1, wherein the performing of the smoothing operation comprises performing the smoothing operation based on an average of pixel values of the selected pixel and other selected pixels.

8. A device for encoding an image, the device comprising:
a block size determiner configured to obtain a quantization parameter, and determine a size of a smoothing block based on the quantization parameter;
a pixel selector configured to select a pixel having a pixel value between threshold values determined with respect to a main pixel in the smoothing block, from among pixels included in the smoothing block;
a smoothing operation performer configured to perform a smoothing operation with respect to the main pixel based on the pixel value of the selected pixel; and
an image encoder configured to encode an image with respect to which the smoothing operation is performed.

9. The device of claim 8, wherein the pixel selector is configured to determine the main pixel of the smoothing block, determine threshold values based on a pixel value of the determined main pixel, and select the pixel having a pixel value between the determined threshold values from among the pixels included in the smoothing block.

10. The device of claim 9, wherein the main pixel is located at an intersection of a central row and a central column in the smoothing block.

11. The device of claim 8, wherein the block size determiner is further configured to determine the size of the smoothing block based on a resolution of the image, a complexity of the image, or a combination of the resolution of the image and a complexity of the image.

12. The device of claim 8, wherein the device is configured to receive input from a user and set the quantization parameter based on the received input.

13. The device of claim 8, wherein the smoothing operation performer is configured to perform the smoothing operation by applying a Gaussian function determined based on the quantization parameter to a pixel value of the selected pixel.

14. The device of claim 8, wherein the smoothing operation performer is configured to perform the smoothing operation based on an average of pixel values of the selected pixel and other selected pixels.

15. A non-transitory computer-readable recording medium having recorded thereon a program for performing the method of claim 1 by using a computer.

16. An image processor configured to process an image, the image processor comprising:
a block size determiner configured to determine a size of a smoothing block within the image,
a pixel selector configured to select a main pixel within the smoothing block and to further select a pixel within the smoothing block based on a characteristic of the main pixel; and
a smoothing operation performer configured to perform a smoothing operation on the main pixel based on the selected pixel.

17. The image processor of claim 16, wherein the block size determiner is configured to determine the size of the smoothing block based on a resolution of the image or a complexity of the image.

18. The image processor of claim 16, wherein the characteristic of the main pixel comprises a pixel value of the main pixel, and the pixel selector is configured to select a pixel, having a pixel value within a range of the pixel value of the main pixel, as the selected pixel.

19. The image processor of claim 18, wherein the range is a contrast range, and the pixel selector is configured to determine the contrast range by applying Weber-Fechner's law to the pixel value of the main pixel.

20. The image processor of claim 19, wherein:
the pixel selector is configured to select a plurality of pixels based on the pixel value of the main pixel, and
the smoothing operation performer is configured to determine a smoothing value of the main pixel by:
multiplying Gaussian function values corresponding to the selected pixels by the pixel values included in the selected pixels to determine multiplication products,
adding the multiplication products together to generate a sum, and
dividing the sum of the multiplication products by a sum of the Gaussian function values to determine the smoothing value.
